(19) United States
(12) Patent Application Publication
(10) Pub. No.: US 2004/0088322 A1
(43) Pub. Date: May 6, 2004

(54) System and method for determining connections between information aggregates

(75) Inventors: Michael D. Elder, Greer, SC (US); Jason Y. Jho, Raleigh, NC (US); Vaughn T. Rokosz, Newton, MA (US); Andrew L. Schirmer, Andover, MA (US); Matthew Schultz, Ithaca, NY (US)

Correspondence Address: Shelley M. Beckstrand, Esq., Attorney at Law, 314 Main St., Owego, NY, 13827-1616, US

(73) Assignee: International Business Machines Corporation, Armonk, NY

(21) Appl. No.: 10/286,212

(22) Filed: Oct. 31, 2002

(51) Int. Cl. G06F 17/00

(52) U.S. Cl. 707/103 Y

(57) ABSTRACT

A system and method for evaluating an information aggregate. A metrics database stores document indicia including document attributes, associated persons and age of creation. A query engine is responsive to a user request and the metrics database for aggregating documents having same, unique attributes in an information aggregate; collects a plurality of documents having non-unique values on a first shared attribute into a first information aggregate and a plurality of documents having non-unique values on a second shared attribute into a second information aggregate. A visualization engine visualizes connections between the first and second information aggregates

### BACKGROUND OF THE INVENTION

### CROSS REFERENCES TO RELATED APPLICATIONS

The following U.S. patent applications are filed concurrently herewith and are assigned to the same assignee hereof and contain subject matter related, in certain respect, to the subject matter of the present application. These patent applications are incorporated herein by reference.

Ser. No. ______, filed ______ for “SYSTEM AND METHOD FOR DETERMINING FOUNDERS OF AN INFORMATION AGGREGATE”, assignee docket LOT920020007US1;

Ser. No. ______, filed ______ for “SYSTEM AND METHOD FOR FINDING THE ACCELERATION OF AN INFORMATION AGGREGATE”, assignee docket LOT920020008US1;

Ser. No. ______, filed ______ for “SYSTEM AND METHOD FOR FINDING THE RECENCY OF AN INFORMATION AGGREGATE”, assignee docket LOT920020009US1;

Ser. No. ______, filed ______ for “SYSTEM AND METHOD FOR EXAMINING THE AGING OF AN INFORMATION AGGREGATE”, assignee docket LOT920020010US1;

Ser. No. ______, filed ______ for “SYSTEM AND METHOD FOR DETERMINING CONNECTIONS BETWEEN INFORMATION AGGREGATES”, assignee docket LOT920020011US1;

Ser. No. ______, filed ______ for “SYSTEM AND METHOD FOR DETERMINING MEMBERSHIP OF INFORMATION AGGREGATES”, assignee docket LOT920020012US1;

Ser. No. ______, filed ______ for “SYSTEM AND METHOD FOR EVALUATING INFORMATION AGGREGATES BY VISUALIZING ASSOCIATED CATEGORIES”, assignee docket LOT920020017US1;

Ser. No. ______, filed ______ for “SYSTEM AND METHOD FOR DETERMINING COMMUNITY OVERLAP”, assignee docket LOT920020018US1;

Ser. No. ______, filed ______ for “SYSTEM AND METHOD FOR BUILDING SOCIAL NETWORKS BASED ON ACTIVITY AROUND SHARED VIRTUAL OBJECTS”, assignee docket LOT920020019US1; and

Ser. No. ______, filed ______ for “SYSTEM AND METHOD FOR ANALYZING USAGE PATTERNS IN INFORMATION AGGREGATES”, assignee docket LOT920020020US1.

### TECHNICAL FIELD OF THE INVENTION

This invention relates to a method and system for analyzing trends in an information aggregate. More particularly, it relates to identifying and visualizing relationships among aggregates.

### BACKGROUND ART

Existing systems for knowledge management are focused primarily on individuals and the documents they create. Such systems typically organize documents along two primary dimensions. First, a physical dimension that reflects a fundamental unit of storage in the underlying system. Examples of physical units of storage include a Notes database (NSF) or a QuickPlace. Second, a topical dimension that collects documents together based on their content or expected usage. Examples of the logical dimension include categories (to group documents that are concerned with a particular topic) or collections (to group documents that are serving a particular purpose).

The user interfaces in existing information systems are therefore concerned with displaying information along these two dimensions. Search interfaces, for example, often allow defining a search based on both the physical and topical dimensions, and of course are focused on returning documents. This approach is useful, but it fails to account for the fact that most work of consequence happens in teams and not at the level of individuals. There is therefore a need to better align information systems with the way people really work by presenting information in terms of groups (for example, teams or communities).

For example, social networks provide methods for determining connections between people, however, they have not heretofore determined connections between information aggregates that have people in common.

Knowledge management system are known which include a valuation step using some user activity to generate a value score for the knowledge resource or autonomous mechanisms for information discovery. But these also focus on the content of each knowledge resource. They focus on grouping similar content. However, these fail to examine usage patterns for more helpful trends.

The Lotus Discovery Server (LDS) is a Knowledge Management (KM) tool that allows users to more rapidly locate the people and information they need to answer their questions. It categorizes information from many different sources (referred to generally as knowledge repositories) and provides a coherent entry point for a user seeking information. Moreover, as users interact with LDS and the knowledge repositories that it manages, LDS can learn what the users of the system consider important by observing how users interact with knowledge resources. Thus, it becomes easier for users to quickly locate relevant information.

There is a need, however, to provide improved visualizations derived from what LDS learns from observing the users. In particular, there is a need to provide visualizations (1) identifying trends in knowledge over time, (2) identifying social networks that form from users' interaction around a shared aggregate resource, (3) enabling inferences about how successfully the system is adopted and utilized by users, and (4) facilitating and encouraging a higher level of adoption.

The focus of LDS is to provide specific knowledge or answers to localized inquiries; focusing users on the documents, categories, and people who can answer their questions. There is a need, however, to magnify existing trends within the system—thus focusing on the system as a whole instead of specific knowledge.

It is, therefore, an object of the invention to provide an improved system and method for evaluating relationships between information aggregates.

### SUMMARY OF THE INVENTION

System and method for evaluating an information aggregate by collecting a plurality of documents having non-unique values on a first shared attribute into a first information aggregate; collecting a plurality of documents having non-unique values on a second shared attribute into a second information aggregate; and identifying and visualizing connections between the first and second information aggregates.

In accordance with an aspect of the invention, there is provided a computer program product configured to be operable for evaluating an information aggregate by collecting a plurality of documents having non-unique values on a first shared attribute into a first information aggregate; collecting a plurality of documents having non-unique values on a second shared attribute into a second information aggregate; and identifying and visualizing connections between the first and second information aggregates.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a diagrammatic representation of visualization portfolio strategically partitioned into four distinct domains in accordance with the preferred embodiment of the invention.

FIG. 2 is a system diagram illustrating a client/server system in accordance with the preferred embodiment of the invention.

FIG. 3 is a system diagram further describing the web application server of FIG. 2.

FIG. 4 is a diagrammatic representation of the XML format for wrapping SQL queries.

FIG. 5 is a diagrammatic representation of a normalized XML format, or QRML.

FIG. 6 is a diagrammatic representation of an aggregate in accordance with the preferred embodiment of the invention.

FIG. 7 is a diagrammatic illustration of people associated with an aggregate.

FIG. 8 is a diagrammatic illustration of people associated in common with a plurality of aggregates.

FIG. 9 is a flow chart illustrating determining membership of a given aggregate.

FIG. 10 is a flow chart illustrating determining the intersection between the member sets of the two aggregates.

FIG. 11 is a flow chart illustrating visualizing first degree community connections in accordance with an exemplary embodiment of the invention.

### DETAILED DESCRIPTION OF PREFERRED EMBODIMENTS

In accordance with the preferred embodiment of the invention, a group-oriented way of presenting information enables the determination and display of the degree of connection between people or agents associated with information aggregates. In an exemplary embodiment of the invention, the connection metric may be implemented in the context of the Lotus Discovery Server (a product sold by IBM Corporation).

The Lotus Discovery Server (LDS) is a Knowledge Management (KM) tool that allows users to more rapidly locate the people and information they need to answer their questions. In an exemplary embodiment of the present invention, the functionality of the Lotus Discovery Server (LDS) is extended to include useful visualizations that magnify existing trends of an aggregate system. Useful visualizations of knowledge metric data store by LDS are determined, extracted, and visualized for a user.

On its lowest level, LDS manages knowledge resources. A knowledge resources is any form of document that contains knowledge or information. Examples include Lotus WordPro Documents, Microsoft Word Documents, webpages, postings to newsgroups, etc. Knowledge resources are typically stored within knowledge repositories—such as Domino.Doc databases, websites, newsgroups, etc.

When LDS is first installed, an Automated Taxonomy Generator (ATG) subcomponent builds a hierarchy of the knowledge resources stored in the knowledge repositories specified by the user. For instance, a document about working with XML documents in the Java programming language stored in a Domino.Doc database might be grouped into a category named ‘Home>Development>Java>XML’. This categorization will not move or modify the document, just record its location in the hierarchy. The hierarchy can be manually adjusted and tweaked as needed once initially created.

A category is a collection of knowledge resources and other subcategories of similar content, generically referred to as documents, that are concerned with the same topic. A category may be organized hierarchically. Categories represent a more abstract re-organization of the contents of physical repositories, without displacing the available knowledge resources. For instance, in the following hierarchy:

Home (Root of the hierarchy)

Animals

Dogs

Cats

Industry News and Analysis

CNN

ABC News

MSNBC

‘Home>Animals’, ‘Home>Industry News and Analysis’, and ‘Home>Industry News and Analysis>CNN’ are each categories that can contain knowledge resources and other subcategories. Furthermore, ‘Home>Industry News and Analysis>CNN’ might contain documents from www.cnn.com and documents created by users about CNN articles which are themselves stored in a Domino.Doc database.

The Discovery Server tracks activity metrics for the documents that it organizes, including when a document is created, modified, responded to, or linked to. When these documents are grouped into collections, the activity metrics can be analyzed to determine the connections between the people associated with the document collections.

A community is a collection of documents that are of interest to a particular group of people collected in an information repository. The Lotus Discovery Server (LDS) allows a community to be defined based on the information repositories used by the community. Communities are defined by administrative users of the system (unlike categories which can be created by LDS and then modified). If a user interacts with one of the repositories used to define Community A, then he is considered an active participant in that community. Thus, communities represent the physical storage of knowledge resources and provide a mechanism for LDS to observe the activity of a group of people.

Another capability of LDS is its search functionality. Instead of returning only the knowledge resources (documents) that a standard web-based search engine might locate, LDS also returns the categories that the topic might be found within and the people that are most knowledge about that topic.

The system and method of the preferred embodiments of the invention are built on a framework that collectively integrates data-mining, user-interface, visualization, and server-side technologies. An extensible architecture provides a layered process of transforming data sources into a state that can be interpreted and outputted by visualization components. This architecture is implemented through Java, Servlets, JSP, SQL, XML, and XSLT technology, and essentially adheres to a model-view controller paradigm, where interface and implementation components are separated. This allows effective data management and server side matters such as connection pooling to be independent

In accordance with the preferred embodiment of the invention, information visualization techniques are implemented through the three main elements including bar charts, pie charts, and tables. Given the simplicity of the visualization types themselves, the context in which they are contained and rendered is what makes them powerful mediums to reveal and magnify hidden knowledge dynamics within an organization.

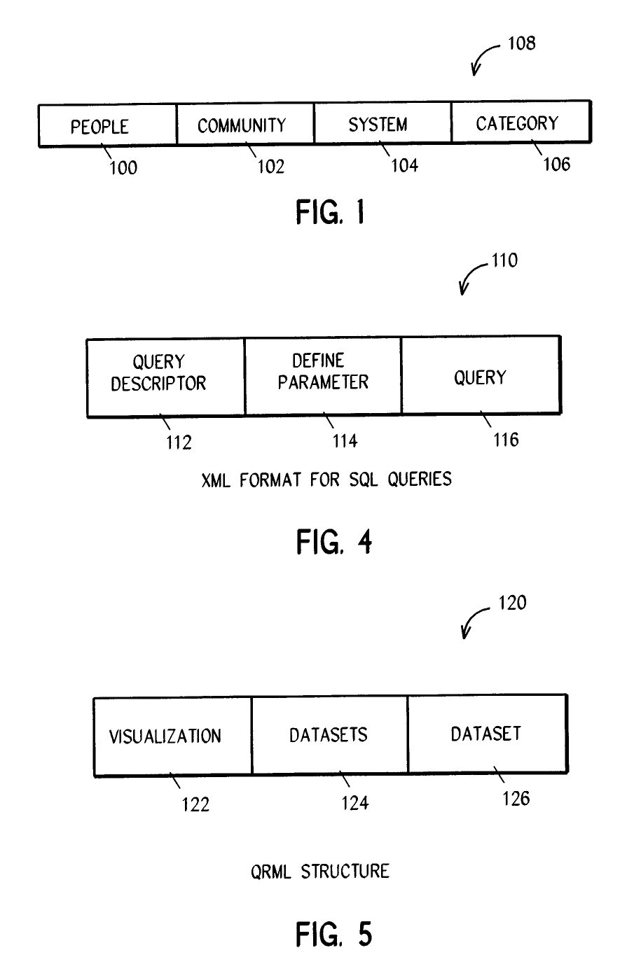

Referring to FIG. 1, a visualization portfolio is strategically partitioned into four distinct domains, or explorers: people 100, community 102, system 104, and category 106. The purpose of these partitioned explorers 100-106 is to provide meaningful context for the visualizations. The raw usage pattern metrics produced from the Lotus Discovery Server (LDS) do not raise any significant value unless there is an applied context to it. In order to shed light on the hidden relationships behind the process of knowledge creation and maintenance, there is a need to ask many important questions. Who are the knowledge creators? Who are the ones receiving knowledge? What group of people are targeted as field experts? How are groups communicating with each other? Which categories of information are thriving or lacking activity? How is knowledge transforming through time? While answering many of these questions, four key targeted domains, or explorer types 100-106 are identified, and form the navigational strategy for user interface 108. This way, users can infer meaningful knowledge trends and dynamics that are context specific.

### People Domain 100

People explorer 100 focuses on social networking, community connection analysis, category leaders, and affinity analysis. The primary visualization component is table listings and associations.

### Community Domain 102

Community explorer 102 focuses on acceleration, associations, affinity analysis, and document analysis for communities. The primary visualization components are bar charts and table listings. Features include drill down options to view associated categories, top documents, and top contributors.

Affinities can be summed up by communities, as they can for categories, as is described hereafter. In particular, this allows communities to be ranked by the volume of expertise exhibited by their members. Since affinities are an indirect measure of activity, this visualization also helps point out how active certain communities are in relation to other communities.

A document activity over time metric allows a more fine-grained measure of community activity. LDS maintains a record of the activity around documents. This means that if a user authors a document, links to a document, accesses a document, etc., LDS remembers this action and later uses this to calculate affinities. However, by analyzing these metrics relative to the available communities, an idea of the aggregate activity of a community in relation to the individual metrics may be derived. That is, by summing all of the ‘author’ metrics for communities A, B, C, etc, and doing this for all possible metrics, yields a quick visualization of the total document activity over time, grouped by community.

In dealing with different communities, it often becomes useful to understand how those communities are related to each other in terms of documents, categories, and their membership base. Are there documents that are important to several communities? Are their categories that span several communities?

With LDS, documents are linked to their respective repositories, which are then linked back to their respective communities. For categories, the aggregate of documents that make up the category are examined by linking the category to the communities that contain the knowledge resources that make up the category.

The above visualizations (Sum of Affinity, Sum of Activity) are very useful in judging the activities of individual people. It is also very useful to understand the activity of people in relation to the group. For this reason, how the activity crosses the boundaries of communities may be analyzed. By looking at the actions of the people within those communities, and understanding is gained of how isolated or how connected each community is in relation to the other communities. In this respect, focus may be on two communities or the sum across all existing communities.

A community membership intersection metric facilitates understanding how people from different communities are connected, which is useful in understanding how people fit into the social network of their organization. LDS records activities around shared knowledge resources, and this information may be used to link people together.

### System Domain 104

System explorer 104 focuses on high level activity views such as authors, searches, accesses, opens, and responses for documents. The primary visualization components are bar charts (grouped and stacked). Features include zooming and scrollable regions.

### Category Domain 106

Category explorer 106 focuses on lifespan, recency, aging acceleration, affinity analysis, and document analysis of categories generated by a Lotus Discovery Server's Automated Taxonomy Generator. The primary visualization components are bar charts. Features include drill down options to view subcategories, top documents, top contributors, category founders, and document activity.

An interesting question to ask is how long a category has been in existence. The metric which illustrates this is ‘category lifespan’. To calculate this value, the difference between the creation dates of the newest document and the oldest in the category is calculated. This metric allows the user to quickly grasp which categories are ‘dead’; that is, the categories for which the user base is not creating new content. Likewise, for new users, they can get a grasp of how long different categories have been in use—helping them better understand the interests of the culture which they are entering.

As users interact with different categories, the system learns which users are attracted to which topics. LDS constructs “scores” known as affinities which rate the level and amount of interaction of different users with different categories. An affinity is a rank that numerically captures how often a user interacts with a particular category compared to the level of interaction of other users. Affinities within the system are important in relation to the other affinities. Once a user's affinity reaches a certain threshold, LDS asks the user if he would like to publish that affinity. These affinities can then be made public, so that when other users search on a topic, LDS can identify users who are knowledgeable on that topic.

These affinities are extremely useful in making inferences about the interests of the users of the system, and in understanding the knowledge trends. In accordance with the present invention, affinities are used to reflect when a particular category (or topic of information) becomes more important than others, indicating that the organization is losing or gaining interest in some topic.

LDS maintains a score for the knowledge resources which are utilized to indicate how important they are to the users of the system. For instance, a document that has a lot of activity around it—such as responses, modifications or simply a high access rate—is perceived as more important than documents which are rarely accessed. This is generically referred to as ‘document value’.

Since affinities vary from category to category, one of the useful questions becomes, “where are the interests of an organization focused?” Where an organization's interests are focused is determined by calculating the sum of all user affinities across all categories. This results in a ranking of the existing categories by the total affinity value for each category. By itself, this value does not convey a lot of information. However, relative to the other rankings, which categories form the focus of an organization and in which categories the organization lacks expertise may be visualized. This allows administrators and managers to determine how the skill base of their employees needs to change (useful in hiring or retraining employees) or to verify that the skill base is in line with company goals.

### System Overview

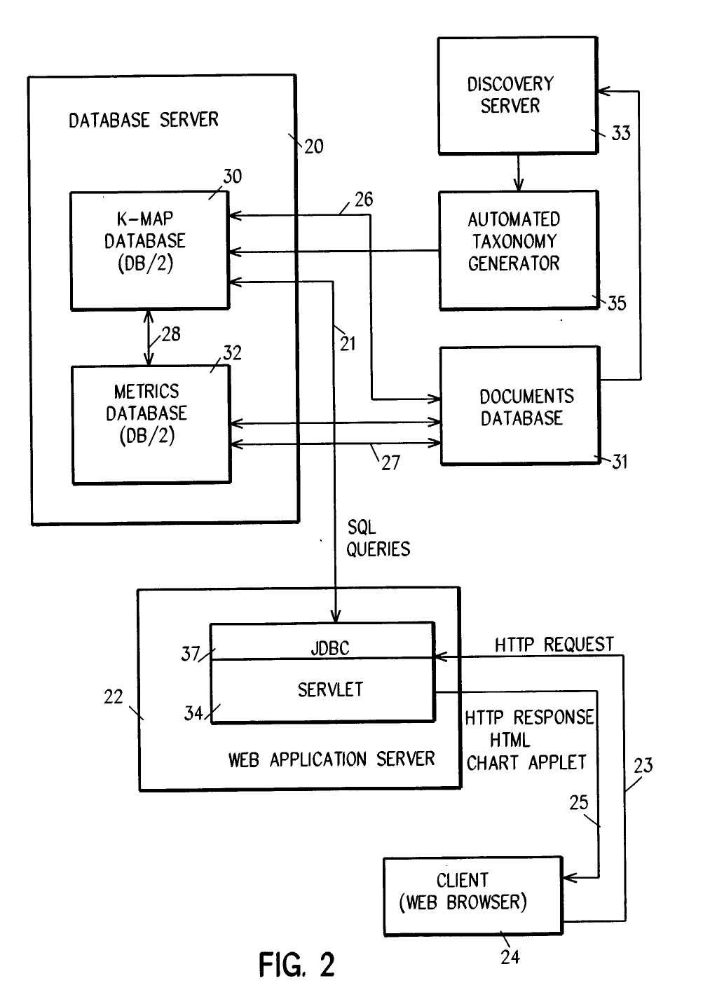

Referring to FIG. 2, an exemplary client/server system is illustrated, including database server 20, discovery server 33, automated taxonomy generator 35, web application server 22, and client browser 24.

Knowledge management is defined as a discipline to systematically leverage information and expertise to improve organizational responsiveness, innovation, competency, and efficiency. Discovery server 33 (e.g. Lotus Discovery Server) is a knowledge system which may deployed across one or more servers. Discovery server 33 integrates code from several sources (e.g., Domino, DB2, InXight, KeyView and Sametime) to collect, analyze and identify relationships between documents, people, and topics across an organization. Discovery server 33 may store this information in a data store 31 and may present the information for browse/query through a web interface referred to as a knowledge map (e.g., K-map) 30. Discovery server 33 regularly updates knowledge map 30 by tracking data content, user expertise, and user activity which it gathers from various sources (e.g. Lotus Notes databases, web sites, file systems, etc.) using spiders.

Database server 20 includes knowledge map database 30 for storing a hierarchy or directory structure which is generated by automated taxonomy generator 35, and metrics database 32 for storing a collection of attributes of documents stored in documents database 31 which are useful for forming visualizations of information aggregates. The k-map database 30, the documents database 31, and the metrics database are directly linked by a key structure represented by lines 26, 27 and 28. A taxonomy is a generic term used to describe a classification scheme, or a way to organize and present information, Knowledge map 30 is a taxonomy, which is a hierarchical representation of content organized by a suitable builder process (e.g., generator 35).

A spider is a process used by discovery server 33 to extract information from data repositories. A data repository (e.g. database 31) is defined as any source of information that can be spidered by a discovery server 33.

Java Database Connectivity API (JDBC) 37 is used by servlet 34 to issue Structured Query Language (SQL) queries against databases 30, 31, 32 to extract data that is relevant to a users request 23 as specified in a request parameter which is used to filter data. Documents database 31 is a storage of documents in, for example, a Domino database or DB2 relational database.

The automated taxonomy generator (ATG) 35 is a program that implements an expectation maximization algorithm to construct a hierarchy of documents in knowledge map (K-map) metrics database 32, and receives SQL queries on link 21 from web application server 22, which includes servlet 34. Servlet 34 receives HTTP requests on line 23 from client 24, queries database server 20 on line 21, and provides HTTP responses, HTML and chart applets back to client 24 on line 25.

Discovery server 33, database server 20 and related components are further described in U.S. Patent application Ser. No. 10,044,914 filed 15 Jan. 2002 for System and Method for Implementing a Metrics Engine for Tracking Relationships Over Time.

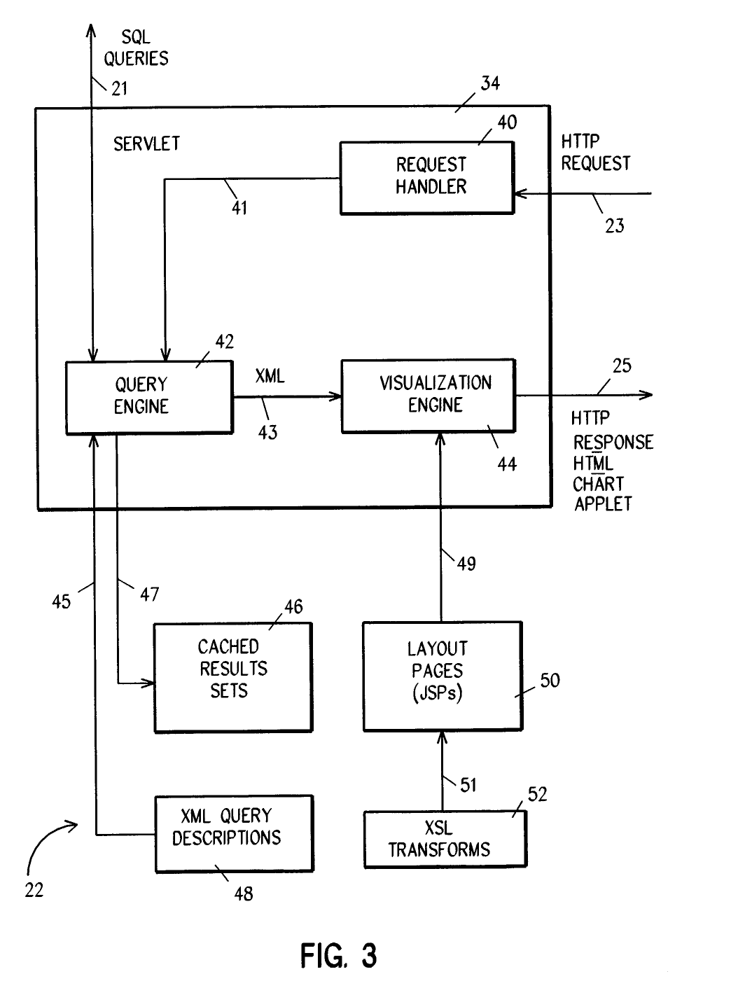

Referring to FIG. 3, web application server 22 is further described. Servlet 34 includes request handler 40 for receiving HTTP requests on line 23, query engine 42 for generating SQL queries on line 21 to database server 20 and result set XML responses on line 43 to visualization engine 44. Visualization engine 44, selectively responsive to XML 43 and layout pages (JSPS) 50 on line 49, provides on line 25 HTTP responses, HTML, and chart applets back to client 24. Query engine 42 receives XML query descriptions 48 on line 45 and caches and accesses results sets 46 via line 47. Layout pages 50 reference XSL transforms 52 over line 51.

In accordance with the preferred embodiment of the invention, visualizations are constructed from data sources 32 that contain the metrics produced by a Lotus Discovery Server. The data source 32, which may be stored in an IBM DB2 database, is extracted through tightly coupled Java and XML processing.

Referring to FIG. 4, the SQL queries 21 that are responsible for extraction and data-mining are wrapped in a result set XML format having a schema (or structure) 110 that provides three main tag elements defining how the SQL queries are executed. These tag elements are

<queryDescriptor> 112, <defineparameter> 114, and <query> 116.

The <queryDescriptor> element 112 represents the root of the XML document and provides an alias attribute to describe the context of the query. This <queryDescriptor> element 112 is derived from http request 23 by request handlekr 40 and fed to query engine 42 as is represented by line 41.

The <defineparameter> element 114 defines the necessary parameters needed to construct dynamic SQL queries 21 to perform conditional logic on metrics database 32. The parameters are set through its attributes (localname, requestParameter, and defaultvalue). The actual parameter to be looked up is requestparameter. The localname represents the local alias that refers to the value of requestParameter. The defaultvalue is the default parameter value.

QRML structure 116 includes <query> element 116 containing the query definition. There can be one or more <query> elements 116 depending on the need for multiple query executions. A<data> child node element is used to wrap the actual query through its corresponding child nodes. The three essential child nodes of <data> are <queryComponent>, <useParameter>, and <queryAsFullyQualified>. The <querycomponent> element wraps the main segment of the SQL query. The <useparameter> element allows parameters to be plugged into the query as described in <defineParameter>. The <queryAsFullyQualified> element is used in the case where the SQL query 21 needs to return an unfiltered set of data.

When a user at client browser 24 selects a metric to visualize, the name of an XML document is passed as a parameter in HTTP request 23 to servlet 34 as follows:

<input type=hidden name=“queryAlias”
value=“AffinityPerCategory”>

In some cases, there is a need to utilize another method for extracting data from the data source 32 through the use of a generator Java bean. The name of this generator bean is passed as a parameter in HTTP request 23 to servlet 34 as follows:

<input type=hidden name=“queryAlias”value=
“PeopleInCommonByCommGenerator”>

Once servlet 34 receives the XML document name or the appropriate generator bean reference at request handler 40, query engine 42 filters, processes, and executes query 21. Once query 21 is executed, data returned from metrics database 32 on line 21 is normalized by query engine 42 into an XML format 43 that can be intelligently processed by an XSL stylesheet 52 further on in the process.

Referring to FIG. 5, the response back to web application server 22 placed on line 21 is classified as a Query Response Markup Language (QRML) 120. QRML 120 is composed of three main elements. They are <visualization> 122, <datasets> 124, and <dataset> 126. QRML structure 120 describes XML query descriptions 48 and the construction of a result set XML on line 43.

The <visualization> element 122 represents the root of the XML document 43 and provides an alias attribute to describe the tool used for visualization, such as a chart applet, for response 25.

The <datasets> element 124 wraps one or more <dataset> collections depending on whether multiple query executions are used.

The <dataset> element 126 is composed of a child node <member> that contains an attribute to index each row of returned data. To wrap the raw data itself, the <member> element has a child node <elem> to correspond to column data.

### Data Translation and Visualization

Referring further to FIG. 3, for data translation and visualization, in accordance with the architecture of an exemplary embodiment of the invention, an effective delineation between the visual components (interface) and the data extraction layers (implementation) is provided by visualization engine 44 receiving notification from query engine 42 and commanding how the user interface response on line 25 should be constructed or appear. In order to glue the interface to the implementation, embedded JSP scripting logic 50 is used to generate the visualizations on the client side 25. This process is two-fold. Once servlet 34 extracts and normalizes the data source 32 into the appropriate XML structure 43, the resulting document node is then dispatched to the receiving JSP 50. Essentially, all of the data packaging is performed before it reaches the client side 25 for visualization. The page is selected by the value parameter of a user HTTP request, which is an identifier for the appropriate JSP file 50. Layout pages 50 receive the result set XML 120 on line 43, and once received an XSL transform takes effect that executes a transformation to produce parameters necessary to launch the visualization.

For a visualization to occur at client 24, a specific set of parameters needs to be passed to the chart applet provided by, for example, Visual Mining's Netcharts solution. XSL transformation 52 generates the necessary Chart Definition Language (CDLs) parameters, a format used to specify data parameters and chart properties. Other visualizations may involve only HTML (for example, as when a table of information is displayed).

An XSL stylesheet (or transform) 52 is used to translate the QRML document on line 43 into the specific CDL format shown above on line 25.

This process of data retrieval, binding, and translation all occur within a JSP page 50. An XSLTBean opens an XSL file 52 and applies it to the XML 43 that represents the results of the SQL query. (This XML is retrieved by calling queryResp.getDocumentElement( )). The final result of executing this JSP 50 is that a HTML page 25 is sent to browser 24. This HTML page will include, if necessary, a tag that runs a charting applet (and provides that applet with the parameters and data it needs to display correctly). In simple cases, the HTML page includes only HTML tags (for example, as in the case where a simple table is displayed at browser 24). This use of XSL and XML within a JSP is a well-known Java development practice.

In Ser. No. ______, filed ______ for “SYSTEM AND METHOD FOR DETERMINING FOUNDERS OF AN INFORMATION AGGREGATE”, assignee docket LOT920020007US1, Table 1 illustrates an example of XML structure 110; Table 2 illustrates an example of the normalized XML, or QRML, structure; Table 3 illustrates an example of CDL defined parameters fed to client 24 on line 25 from visualization engine 44; Table 4 illustrates an example of how an XSL stylesheet 52 defines translation; and Table 5 is script illustrating how prepackaged document node 43 is retrieved and how an XSL transformation 52 is called to generate the visualization parameters.

An exemplary embodiment of the system and method of the invention may be built using the Java programming language on the Jakarta Tomcat platform (v3.2.3) using the ModelView-Controller (MVC) (also known as Model 2) architecture to separate the data model from the view mechanism.

### Information Aggregate

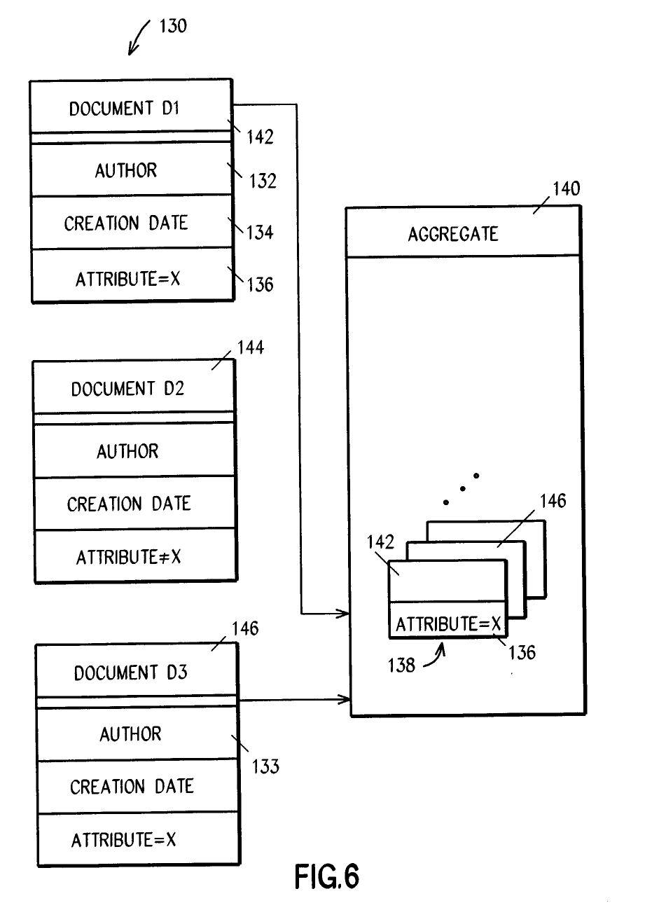

Referring to FIG. 6, a system in accordance with the present invention contains documents 130 such as Web pages, records in Notes databases, and e-mails. Each document 130 is associated with its author 132, and the date of its creation 134. A collection of selected documents 130 forms an aggregates 140. An aggregate 140 is a collection 138 of documents 142, 146 having a shared attribute 136 having non-unique values. Documents 138 can be aggregated by attributes 136 such as:

Category—a collection of documents 130 about a specific topic.

Community—a collection of documents 130 of interest to a given group of people. This type of collection can be formed by identifying a set of knowledge repositories used by a community or team, and then forming the collection from the union of documents contained in the specified repositories.

Location—a collection of documents 130 authored by people in a geographic location (e.g. USA, Utah, Massachusetts, Europe).

Job function or role—a collection of documents 130 authored by people in particular job roles (e.g. Marketing, Development).

Group (where group is a list of people)— a collection of documents authored by a given set of people.

Any other attributed 136 shared by a group (and having non-unique values).

### Aggregate Connections

In accordance with the preferred embodiment of the present invention, a group-oriented way of presenting information enables the determination and display of the degree of connection between people or agents associated with information aggregates. Having a sense of how many and what kinds of connections exist between two information aggregates facilitates:

Evaluating whether the people involved are collaborating effectively (in the case where the information aggregates represent work output of two or more teams).

Understanding something about the way information is used, which may in turn help identify potentially useful sources of information.

Identifying the people who work across teams or communities.

In accordance with the preferred embodiment of the invention, a system is provided having the following characteristics:

The system contains documents. (Examples of documents include Web pages, records in Notes databases, and e-mails).

Document activity can be tracked and time stamped. Examples of tracked activities include (but is not limited to) any or all of the following: when the document was created; when someone responds to a document (for example, as in a discussion database or newsgroup); when a document is modified; and when someone creates a new document that contains a reference to the original document.

Documents can be collected together into aggregates. One example of an aggregate is a category which groups together documents that concern a particular topic.

Examples of how documents can be aggregated are described in the preceding section.

In accordance with the preferred embodiment of the invention, a method is provided for determining the connections that exist between any two information aggregates.

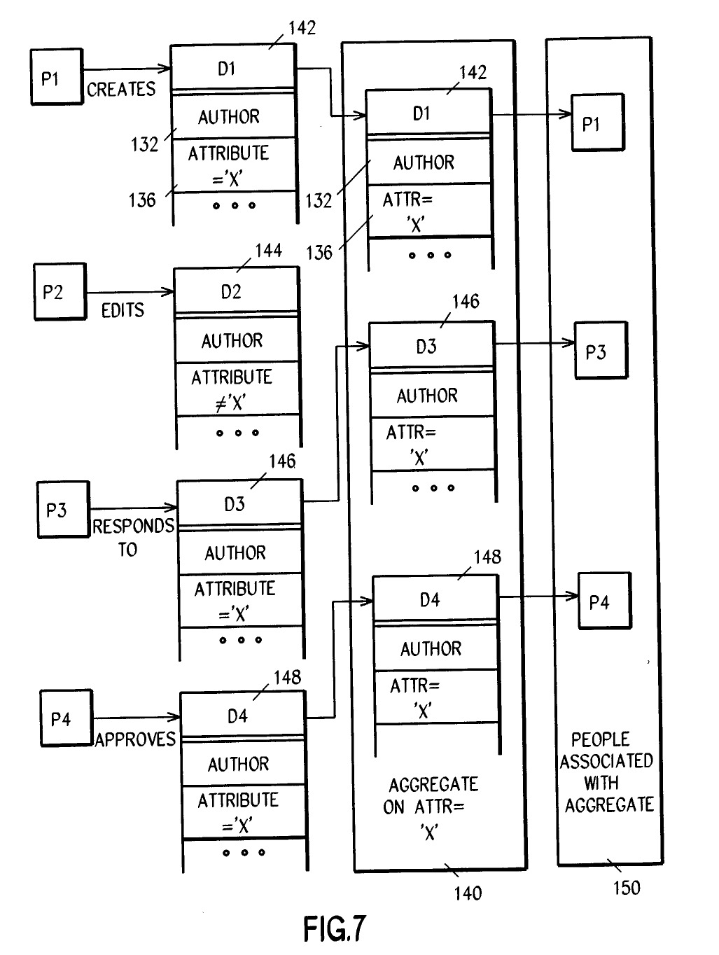

Referring to FIG. 7, people may be associated with an aggregate in several ways. For example, person P1 is associated with document D1 as its creator, person P2 is associated with document D2 as its editor, person P3 is associated with document 146 as a responder, and person P4 is associated with document 148 as its approver. Aggregate 140 on attribute X includes documents 142, 146, and 148, and therefore people 150 associated with aggregate 140 include persons P1, P3 and P4.

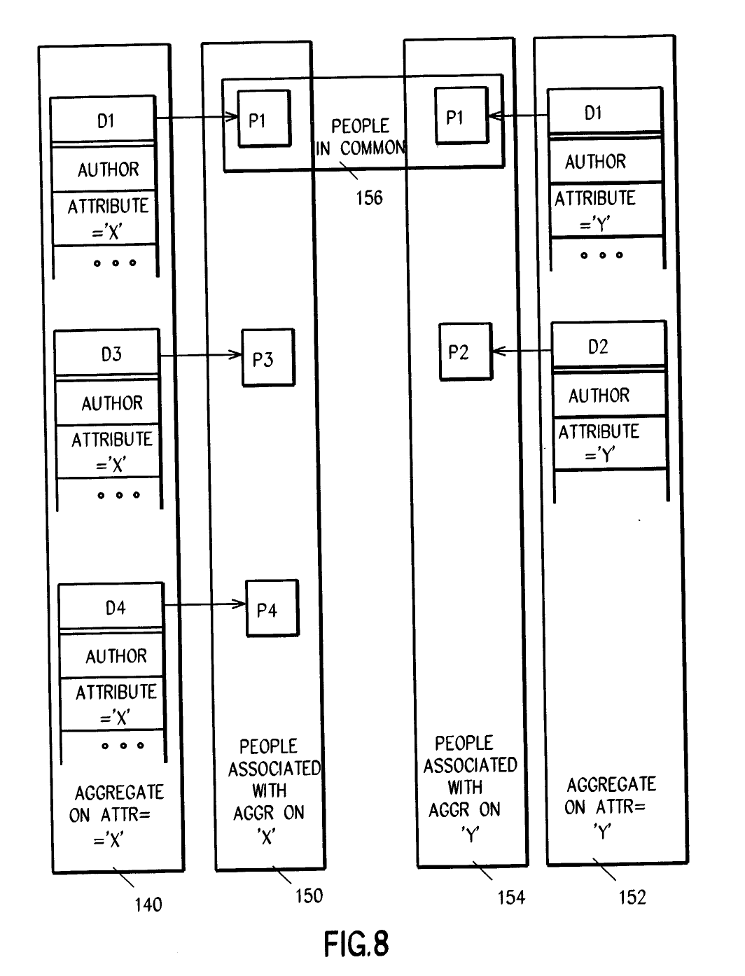

Referring to FIG. 8, people may associated in common with a plurality of aggregates. In this case, person P1 is associated with document D1 in aggregate 152 on attribute Y, and person P2 with document D2 in aggregate Y. As in FIG. 7, person D1 is also associated with document D1 in aggregate 140 on attribute X. Therefore, people in common 156 includes person P1.

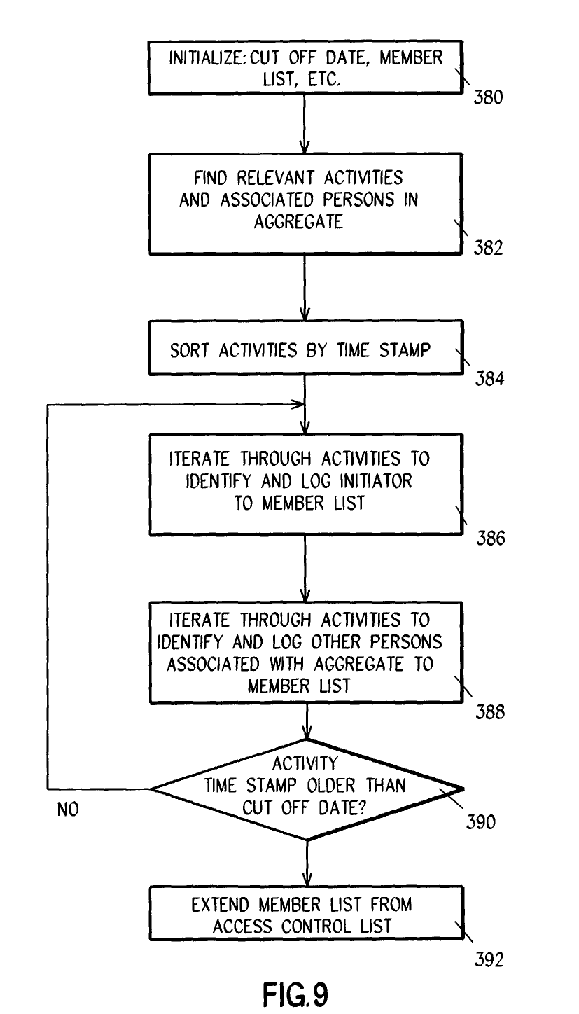

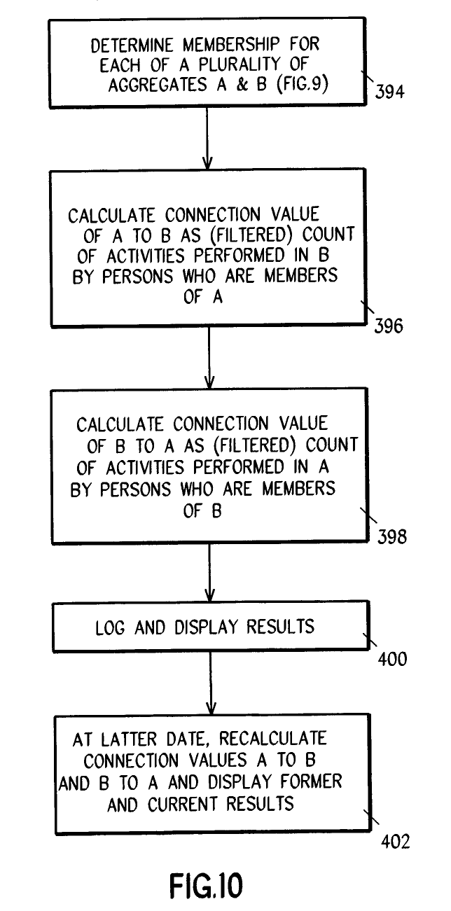

Referring to FIG. 9, the people associated with a given aggregate (its membership) is determined as follows.

In step 380, a cut off date is initialized, as is the member list.

In step 382, relevant activities and the people associated with these activity are found, and in step 384 sorted by time stamp.

In step 386, the sorted activities are iterated through in time stamp order to find and log to the member list the person (or agent) who initiated the activity.

In step 388, the sorted activities are iterated through to identify and log to the member list other persons associated with the aggregate. For example, a document that is posted for review might contain the names of people who have been asked to review the document. The list of reviewers should then be added to the membership list of the aggregate.

In step 390, searching for membership is stopped upon encountering activity time stamps that are older than a specified cutoff date.

In step 392, the access control list (ACL) of the aggregate (where applicable) is used to extend the membership list. For example, the access control list of an aggregate such as a Quickplace or a File Cabinet in Domino.Doc. Such aggregates often explicitly list in a ACL people who have access to the aggregate, from which can be inferred that access implies membership.

The notion of membership encompasses the thought that non-human agents (such as computers or software agents) may be interacting with documents, and may or may not be included in the membership list.

In basic systems, membership may be based solely on document creation, with only initiators logged to the membership list. In this case, step 388 is not executed, and only those identified in step 386 would be considered a member of the aggregate. For more advanced systems (step 388), any tracked activity may yield members, so that persons would be considered a member of the aggregate if they showed any activity at all around the documents in the aggregate, including opens, edits, responses, or links, or if they were referenced within a document contained in the aggregate.

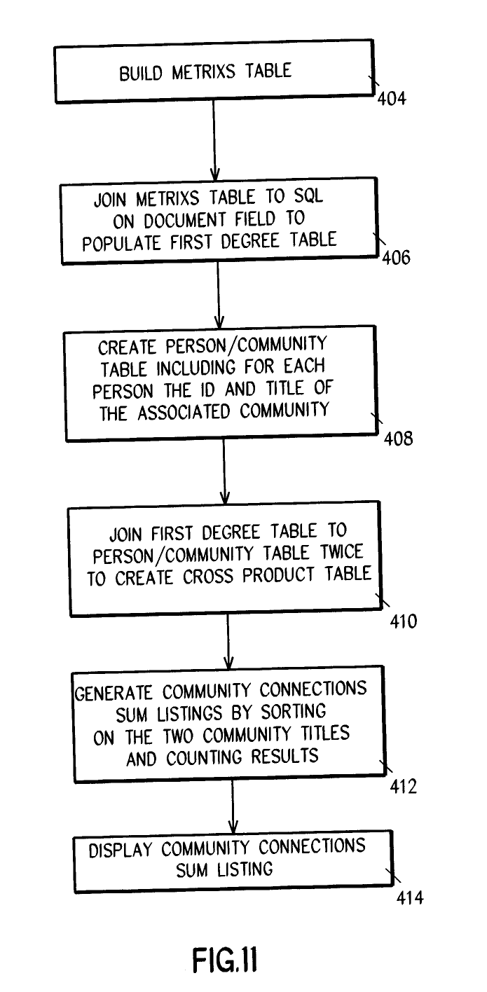

Referring to FIG. 10, after repeating steps 380 through 392 for two aggregates A and B, the intersection between the member sets of the two aggregates may be determined. In step 394, the connection value from A to B calculated as the count of activities performed in B by people who are members of A. In step 396, the connection value from B to A is the count of activity in A for those people who are members of B.

By way of example, given two information aggregates that represent a collection of documents of interest to two different communities A and B, where

Membership set of A={“Alice”, “Edward”, “Fred”}

Membership set of B={“Bob”, “Darlene”, “Edward”}

The intersection of the membership of A and B is {“Edward”). Therefore, the connection value for A to B is the count of Edward's activities against the documents in B. The connection value for B to A is the count of Edward's activities against the documents in A.

It doesn't necessarily follow that a person's activity in the context of B implies that communication is actually flowing between A and B (even if the person is a member of each community), since a person's activity in B may be exclusively focused on B-related ideas. On the other hand, people seldom separate their concerns so rigidly, so it is reasonable to infer that there is some leakage between communities.

A variant from the above is to broaden the analysis to include interactions outside of the communities A and B being considered. In this case, of interest is evidence of any connection between people that two communities have in common, even if that connection occurs in a completely different context. So, if Jack is a member of community A and B, the connection value from A to B may be calculated as either: the count of Jack's interactions with the documents in B, or the count of Jack's interactions with people in B, as inferred from activity around shared documents (even if those documents are not in B). These broader connections are referred to as second degree or higher connections, whereas first degree connections refer to interactions that are restricted to the two aggregates being analyzed.

There are other ways of doing the analysis, including consideration of how balanced people are in their participation across aggregates. In this case, people who participate heavily in two aggregates may be people who are likely to represent conduits of information between the two aggregates. People who occasionally visit one aggregate but participate heavily in another might be less likely to serve as information conduits. Thus, a person's “balance” metric from A to B is determined as the count of that person's activity in A divided by the total count of that person's activities in A and B. When this value is 0.5, the person is participating equally in both aggregates. A low value means that the person is participating mostly in B. An “aggregate balance” metric for A to B sums up the activities for all people in common between A and B in A, and divides by their total activity in A and B. Other algorithms can be applied using various weighting factors or other formulas to define balance. In step 400, tables or charts of the balance metrics for all people in common between A and B are displayed.

Another variation is to analyze interactions between communities based on their content. Rather than simply use raw counts of activity, in steps 396 and 398 the counts may be filtered to include activity on common topics. This is done as follows. Again considering the set of people or agents in common to A and B, determine the topics or keywords associated with the documents they work with in A, and in B. Then, determine the intersection of topics (to find the topics that people in common to A and B work with in both A and B). The results are then used to generate a “connection” report of several varieties, including a raw list of common topics for common people, a count of common topics (as the “connection” metric), and a percentage of each topic in A and B.

In step 402, the above calculations are made periodically in order to capture trends over time. So whatever the connection metric, changes in the connection metric may be tracked over time.

The Lotus Discovery Server (LDS) tracks activity metrics for the documents that it organizes, so that it is known when a document is created, modified, responded to, or linked to. This information may then be used to find all people who are active around a common document and to determine the set of people who are associated with each community. By taking a cross-product of the people-to-community data and the data on activity around common documents, the connections between two communities is then derived.

Referring to FIG. 11, in accordance with an exemplary embodiment of the invention, a “first_degree” table is created that describes the interactions that people share between documents. This starts in step 404 with a metrics table, which contains records in the style illustrated in

TABLE 1
METRICS TABLE

| | |
|---|---|
| person1 | modified document1 |
| person2 | responded to document1 |
| person3 | modified document1 |

In step 406, the relational database language (SQL) that populates the first_degree table joins the metrics table (Table 1) to itself on the document field, so that records in first_degree appear as in Table 2.

TABLE 2
RECORDS IN FIRST DEGREE

| | |
|---|---|
| person1 | modified person2 responded |
| person1 | modified person3 modified |
| person2 | responded person3 modified |
| person2 | responded person1 modified |
| person3 | modified person2 responded |
| person3 | modified person1 modified |

In step 408, a Person/Community table is created that includes for each person the id and the title of the associated community. (Table 3). This table draws on two other sources of information: a table that associates a community with a set of information repositories, and a meta-data table for documents that associates each document with its repository.

TABLE 3
PERSON/COMMUNITY

| | |
|---|---|
| person1 | LDS |
| person2 | LDS |
| person1 | portal |
| person3 | portal |
| person3 | LDS |

In step 410, the connections logic works by joining the first_degree table to the Person/Community table twice, giving a cross-product as illustrated in Table 4.

TABLE 4
CROSS PRODUCT

| | |
|---|---|
| person1 | modified person2 responded person1 LDS person2 LDS |
| person1 | modified person2 responded person1 portal person2 |
| | LDS |
| person1 | modified person3 modified person1 LDS person3 LDS |
| person1 | modified person3 modified person1 portal person3 LDS |
| person1 | modified person3 modified person1 LDS person3 portal |
| person1 | modified person3 modified person1 portal person3 |
| | portal |
| person2 | responded person3 modified person2 LDS person3 LDS |
| person2 | responded person3 modified person2 LDS person3 |
| | portal |
| person2 | responded person1 modified person2 LDS person1 LDS |
| person2 | responded person1 modified person2 LDS person1 |
| | portal |
| person3 | modified person2 responded person3 portal person2 |
| | LDS |
| person3 | modified person2 responded person3 LDS person2 LDS |
| person3 | modified person1 modified person3 portal person1 LDS |
| person3 | modified person1 modified person3 LDS person1 LDS |
| person3 | modified person1 modified person3 portal person1 |
| | portal |
| person3 | modified person1 modified person3 LDS person1 portal |

Finally, in step 412, by sorting on the two community titles and counting the results, the output illustrated in Table 5 is generated and in step 414 displayed.

TABLE 5
COMMUNITY CONNECTIONS SUM LISTING

| | | # CON- |
|---|---|---|
| COMMUNITY | COMMUNITY | NECTIONS |
| LDS | LDS | 763 |
| LDS | PORTALS AT LOTUS | 606 |
| LDS | WORKFLOW & DOC MGT | 34 |
| PORTALS AT LOTUS | LDS | 602 |
| PORTALS AT LOTUS | PORTALS AT LOTUS | 583 |
| PORTALS AT LOTUS | WORKFLOW & DOC MGT | 25 |
| WORKFLOW & DOC | LDS | 27 |
| MGT | | |
| WORKFLOW & DOC | PORTALS AT LOTUS | 15 |
| MGT | | |
| WORKFLOW & DOC | WORKFLOW & DOC MGT | 1216 |
| MGT | | |

The asymmetry seen in Table 5 is caused by people who do not belong to all of the communities being examined. If everyone belonged to all communities, the LDS->Portals and Portals->LDS counts (606 and 602, respectively) would be the same.

In accordance with this embodiment of the invention, starting with a record of each pair of people who have interacted around a common document, and knowing to which communities these people belong, if two people interact around any document, that is counted as a connection between all communities to which the people belong. Thus, if a first person and a second person interact around a document (say the first person creates it and the second person responds to it), if the second person belongs to communities A and B, and the first person belongs to B, then the connections between communities would be incremented as follows:

| | |
|---|---|
| B -> A | 1 |
| B -> B | 1 |

If both persons belonged to both communities A and B, the connections get incremented as follows:

| | |
|---|---|
| A -> A | 1 |
| A -> B | 1 |
| B -> B | 1 |
| B -> A | 1 |

### ADVANTAGES OVER THE PRIOR ART

It is, therefore, an advantage of the invention that there is provided an improved system and method for evaluating relationships between information aggregates.

### Alternative Embodiments

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, P1/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. Method for evaluating an information aggregate, comprising:
collecting a plurality of documents having non-unique values on a first shared attribute into a first information aggregate;
collecting a plurality of documents having non-unique values on a second shared attribute into a second information aggregate; and
identifying and visualizing connections between said first and second information aggregates.

2. The method of claim 1, said connections being first degree connections.

3. The method of claim 1, said connections being second or higher degree connections.

4. The method of claim 2, further comprising:
determining membership of an information aggregate as persons associated with said aggregate as initiators.

5. The method of claim 4, further comprising:
determining membership of said information aggregate as including persons associated with said aggregate by virtue of opens, edits, responses or links.

6. The method of claim 4, further comprising:
determining membership of said information aggregate as initiators during a first specified time period.

7. The method of claim 4, further comprising:
determining an intersection of member sets between said first aggregate and said second aggregate;
calculating a first connection value from said first aggregate to said second aggregate as a count of activities performed in said second aggregate by members of said first aggregate;
calculating a second connection value from said second aggregate to said first aggregate as a count of activities performed in said first aggregate by members of said second aggregate; and
visualizing said first and second connection values.

8. The method of claim 7, further comprising:
calculating and visualizing balance metrics for persons common to said first and second aggregates.

9. The method of claim 7, further comprising:
calculating and visualizing an aggregate balance metric for said first and second aggregates.

10. The method of claim 7, further comprising:
filtering and visualizing said counts based on content.

11. The method of claim 6, further comprising:
identifying connections between said first and second information aggregates for a second time period; and
visualizing said connections for said first and second time periods.

12. A system for evaluating an information aggregate, comprising:
means collecting a plurality of documents having non-unique values on a first shared attribute into a first information aggregate;
means for collecting a plurality of documents having non-unique values on a second shared attribute into a second information aggregate; and
means for identifying and visualizing connections between said first and second information aggregates.

13. A system for evaluating an information aggregate, comprising:
a metrics database for storing document indicia including document attributes, associated persons and age of creation;
a query engine responsive to a user request and said metrics database for aggregating documents having same, unique attributes in an information aggregate;
said query engine further for
collecting a plurality of documents having non-unique values on a first shared attribute into a first information aggregate;
collecting a plurality of documents having non-unique values on a second shared attribute into a second information aggregate; and
a visualization engine for visualizing connections between said first and second information aggregates.

14. The system of claim 13, said connections being first degree connections.

15. The system of claim 13, said connections being second or higher degree connections.

16. The system of claim 14, said query engine further determining membership of an information aggregate as persons associated with said aggregate as initiators.

17. The system of claim 16, said query engine further determining membership of said information aggregate as including persons associated with said aggregate by virtue of opens, edits, responses or links.

18. The system of claim 16, said query engine further determining membership of said information aggregate as initiators during a first specified time period.

19. The system of claim 16, said query engine further:
determining an intersection of member sets between said first aggregate and said second aggregate;
calculating a first connection value from said first aggregate to said second aggregate as a count of activities performed in said second aggregate by members of said first aggregate;
calculating a second connection value from said second aggregate to said first aggregate as a count of activities performed in said first aggregate by members of said second aggregate; and
visualizing said first and second connection values.

20. The system of claim 19,
said query engine further calculating balance metrics for persons common to said first and second aggregates; and
said visualization engine further visualizing said balance metrics.

21. The system of claim 19,
said query engine further calculating an aggregate balance metric for said first and second aggregates; and
said visualization engine further visualizing said aggregate balance metric.

22. The system of claim 19,
said query engine further filtering said counts based on content; and
said visualization engine further visualizing said counts.

23. The system of claim 18, further comprising:
said query engine further identifying connections between said first and second information aggregates for a second time period; and
said visualization engine further visualizing said connections for said first and second time periods.

24. A program storage device readable by a machine, tangibly embodying a program of instructions executable by a machine to perform method steps for evaluating an information aggregate, said method comprising:
collecting a plurality of documents having non-unique values on a first shared attribute into a first information aggregate;
collecting a plurality of documents having non-unique values on a second shared attribute into a second information aggregate; and
identifying and visualizing connections between said first and second information aggregates.

25. The program storage device of claim 24, said method further comprising:
determining an intersection of member sets between said first aggregate and said second aggregate;
calculating a first connection value from said first aggregate to said second aggregate as a count of activities performed in said second aggregate by members of said first aggregate;
calculating a second connection value from said second aggregate to said first aggregate as a count of activities performed in said first aggregate by members of said second aggregate; and
visualizing said first and second connection values.

26. The program storage device of claim 24, said method further comprising:
determining membership of said information aggregates as initiators during a first specified time period;
determining membership of said information aggregates as initiators during a second specified time period;
identifying connections between said first and second information aggregates for said first and second specified time periods; and
visualizing said connections for said first and second time periods.

27. A computer program product for evaluating an information aggregate according to the method comprising:
collecting a plurality of documents having non-unique values on a first shared attribute into a first information aggregate;
collecting a plurality of documents having non-unique values on a second shared attribute into a second information aggregate; and
identifying and visualizing connections between said first and second information aggregates.
